(19) United States
(12) Patent Application Publication
(10) Pub. No.: US 2004/0211394 A1
(43) Pub. Date: Oct. 28, 2004

(54) Fuel return passage for an internal combustion engine

(76) Inventors: James H. Yager, Saint Charles, IL (US); Anthony M. Anello, Bartlett, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 10/422,180

(22) Filed: Apr. 24, 2003

(51) Int. Cl. F02M 55/02

(52) U.S. Cl. 123/468; 123/514

(57) ABSTRACT

An apparatus for and method of returning surplus fuel from a fuel injector (103) utilizes an internal channel (108) of the fuel injector (103) and a fuel return passage in a cylinder head (101) of an internal combustion engine (100). Each fuel injector (103) may be partially disposed in the fuel return passage (113), which may have openings (301) that are at least partially shaped to receive at least a part of the fuel injector (103). One or more ports (109) through which surplus fuel exits the fuel injector (103) are disposed adjacent to an optional groove (111) or adjacent to the openings (301) of the fuel return passage (113). External fuel return lines to each of the fuel injectors (103) are thus eliminated.

### FIELD OF THE INVENTION

This invention relates to internal combustion engines, including but not limited to fuel returns for internal combustion engines utilizing high pressure common rail to deliver fuel to fuel injectors.

### BACKGROUND OF THE INVENTION

Internal combustion engines are known to utilize fuel injectors to provide fuel to a combustion chamber. In some systems, surplus fuel is returned to the fuel tank. Typically, such fuel return systems include an individual return tube from each fuel injector, and each tube feeds into an accumulator tank. In addition, some fuel return systems include a fuel cooler, because the fuel temperature may be too high. Such return tubes, tanks, and coolers are external to the cylinder head and, in addition to taking up extra space, provide the added risk of fuel leakage in the engine compartment.

Accordingly, there is a need for a fuel return system that takes up less space, requires fewer components, and has less risk of leakage.

### SUMMARY OF THE INVENTION

An internal combustion engine includes a cylinder head having a fuel return passage. One or more fuel injectors are disposed within the cylinder head. The one or more fuel injectors include an internal passage arranged and constructed to deliver surplus fuel into the fuel return passage of the cylinder head. At least a part of one of the fuel injectors is disposed in the fuel return passage. A common rail is arranged and constructed to provide fuel to the one or more fuel injectors.

### BRIEF DESCRIPTION OF THE DRAWINGS

FIG. 1 is a cross-sectional diagram of a fuel injector disposed in a cylinder head having a fuel return passage in accordance with the invention.

FIG. 2 is a top view of a cross-section of a fuel return passage engaged with a fuel injector in accordance with the invention.

FIG. 3 is a top view of a cross-section of a fuel return passage engaged with multiple fuel injectors in accordance with the invention.

FIG. 4 is a side view of a fuel return passage in accordance with the invention.

FIG. 5 and FIG. 6 are top views of a fuel return passage engaged with a fuel injector shown in cross-section in accordance with the invention.

### DESCRIPTION OF A PREFERRED EMBODIMENT

The following describes an apparatus for and method of returning surplus fuel from a fuel injector through an internal channel of the fuel injector and into a fuel return passage in a cylinder head of an internal combustion engine. Each fuel injector may be partially disposed in the fuel return passage, which may have openings that are at least partially shaped to receive at least a part of the fuel injector. One or more ports through which surplus fuel exits the fuel injector are disposed adjacent to an optional groove or adjacent to the openings of the fuel return passage. External fuel return lines to each of the fuel injectors are thus eliminated.

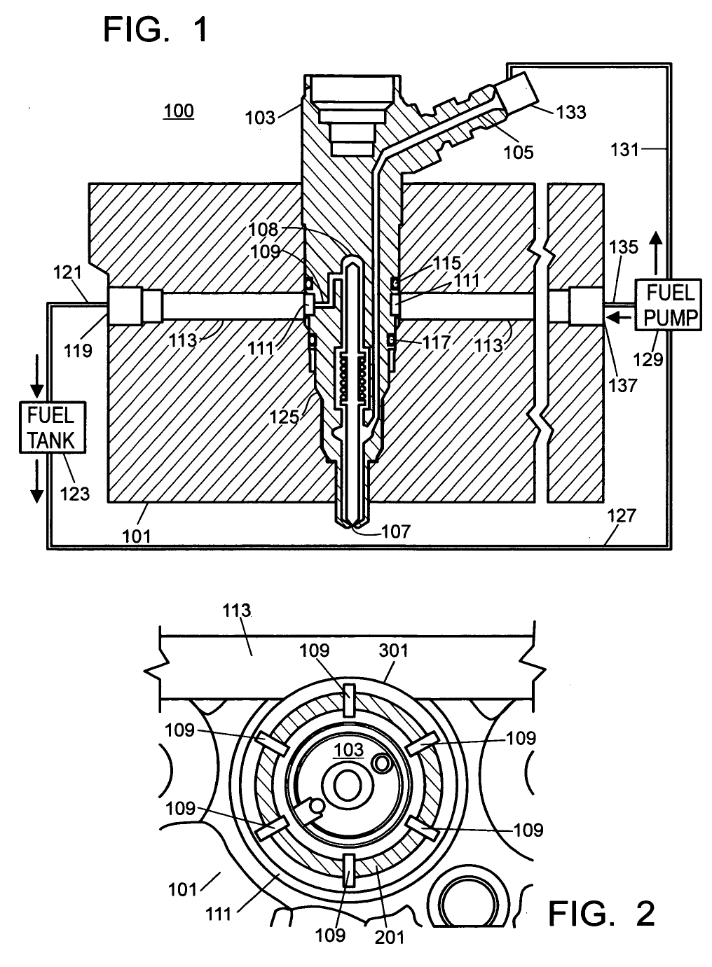

A cross-sectional diagram of a fuel injector disposed in a cylinder head having a fuel return passage is shown in FIG. 1. A cylinder head 101 for an internal combustion engine has one or more fuel injectors 103 disposed therein. Fuel enters a fuel supply passage 105 in the fuel injector 103. Fuel is injected from the fuel injector 103 through a needle 107 and into a combustion chamber (not shown). Surplus fuel may be present in the fuel injector 103 or the fuel pump 127. Surplus fuel may be fuel not combusted in a fuel injection event, fuel from a leak, or fuel that is desired to be returned to the fuel tank 123 for any reason.

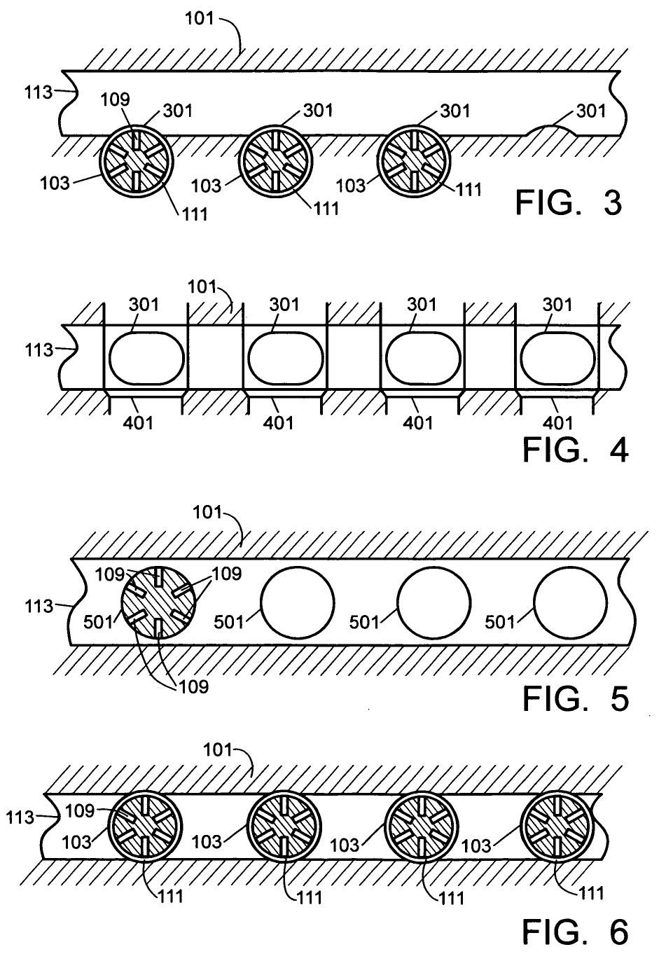

The fuel injector 103 includes one or more internal channels 108 that return surplus fuel through one or more ports 109 into a groove 111 that encircles at least a part of the outer diameter of the fuel injector 103 at the location of the ports 109. The groove 111 may fully encircle the fuel injector 103 in an annular manner or may partially encircle the fuel injector 103 in a partially annular manner. The groove 111 is advantageously adjacent to or intersects with the fuel return passage 113. Fuel from the groove 111 is directed into a fuel return passage 113 disposed in the cylinder head 101. The groove 111 is optional, as fuel may be directly output from the ports 109 into the fuel return passage 113. Use of the groove 111, however, provides the benefit of not having to align the ports 109 with the openings 301 (see FIG. 3 and FIG. 4) of the fuel return passage 113. The length of the fuel return passage 113 is advantageously substantially perpendicular to the length of the fuel injectors 103.

A top view of a cross-section of a fuel return passage 113 engaged with a fuel injector 103 is shown in FIG. 2. The fuel return passage 113, as disposed in the cylinder head 101, has a plurality of openings 301 (see FIG. 3 and FIG. 4) that are generally shaped to receive at least a part of a fuel injector 103. An internal conduit 201 of the fuel injector directs surplus fuel into the ports 109 that direct fuel into the groove 111. The internal conduit 201 may be part of or intersects with the internal passage(s) 108 as shown in FIG. 1, and although it is shown as circular, it may take on any shape. The groove 111 intersects the opening 301 of the fuel return passage 113, such that surplus fuel travels from the internal channel 201, out the ports 109, through the groove 111, and into the fuel return passage 113.

A top view of a cross-section of a fuel return passage engaged with a fuel injector is shown in FIG. 3. The fuel return passage 113, as disposed in the cylinder head 101, has a plurality of openings 301 that are generally shaped to receive at least a part of a fuel injector 103. The groove 111 for each fuel injector 103 intersects with an opening 301, such that when surplus fuel exits the port 109, it enters the groove 111 and is guided into the fuel return passage 113. Although FIG. 3 shows six ports 109 in the fuel injector 103, one or more ports 109 may be successfully utilized.

A side view of the fuel return passage 113, as disposed in the cylinder head 101, is shown in FIG. 4. The side view of the fuel return passage 113 shows the openings 301 to the fuel return passage 113. Each opening 301 is within the bore 401 in which the fuel injector 103 is disposed.

The openings 301 are shown as evenly sized and spaced, although they may be of different sizes and/or unevenly spaced. Each fuel injector 103 is typically associated with an opening 301.

In an alternative embodiment, the fuel return passage 113 may be large enough and have openings 301 wide enough to receive the entire outer diameter of the fuel injector 103 at the point where the fuel injector 103 meets the fuel return passage 113, such as shown in FIG. 5. In this embodiment, multiple ports 109 may be used to direct fuel into the fuel return passage at any point along the outer diameter of the fuel injector 103 where the fuel injector is disposed within the fuel passage 113. The groove 111 is not necessary in this embodiment.

Alternatively, the outer diameter of the fuel injector 103 may be larger than the outer diameter of the fuel return passage 113 as shown in FIG. 6. In one embodiment, additional passages are formed beyond the outer diameter of the fuel return passage 113 and beyond the outer diameter of the fuel injector 103 to allow surplus fuel to return from the ports 109 through the additional passages and into the fuel return passage 113. In another embodiment, the bore 401 for the fuel injector 103 extends beyond the outer diameter of the fuel return passage 113, but additional passages are not formed to return fuel return to the fuel return passage 113. Although the groove 111 is optionally utilized in either embodiment, it would be advantageously utilized in the latter embodiment.

Referring back to FIG. 1, O-ring seals 115 and 117 are disposed between the fuel injector 103 and the cylinder head 101 to prevent the surplus fuel from leaking out between the fuel injectors 103 and the cylinder head 101. As shown in FIG. 1, one O-ring 115 is disposed above the fuel return passage 113 and one O-ring 117 is disposed below the fuel return passage 113. The O-rings 115 and 117 seal the ports 109 and grooves 111 of the fuel injectors 103 with the fuel return passage 113 such that fuel does not leak out between the cylinder head 101 and the fuel injectors 103.

Surplus fuel exits a port 119 in the cylinder head 101 and enters a fuel line 121 for return to the fuel tank 123 of the vehicle in which the internal combustion engine 100 is disposed. As shown, only one line 121 external to the engine is utilized for fuel return, rather than other return systems that utilize a line for each fuel injector. Two lines may be utilized for V-type engines, one for each bank, or an internal passage in the cylinder head 101 may connect the fuel return passage 113 for each bank together, requiring only one external fuel line. Thus, many external lines and their interconnections are eliminated, thereby reducing the risk of fuel leaks.

A sleeve 125 may be disposed between each of the fuel injectors 103 and the cylinder head 101. The sleeve may be comprised of a drawn steel cup that separates the fuel injector body from coolant channels in the cylinder head 101. Thus, appropriate use of such a sleeve 125 may eliminate the need for a separate cooling system for the return fuel, thereby saving space and cost for the engine 100.

A high-pressure common-rail fuel system is shown in FIG. 1 as supplying fuel to the fuel injectors. Fuel from the fuel tank is provided via a fuel pump line 127 to a fuel pump 129. A high pressure fuel pump 127 provides fuel via a supply line 131 to a common rail 133 that delivers the fuel to the fuel injectors 103. Other types of fuel supply systems may be utilized with the present invention. The fuel injectors 103 receive high pressure fuel from the common rail fuel system, as shown in FIG. 1. In order to regulate fuel pressure in the fuel injectors 103, surplus fuel is allowed to escape via the internal channels 108 and return to the fuel tank 123. Prior to removal from the fuel injector 103, surplus fuel is used to operate the needle 107 of the fuel injector 103 by means of a two-orifice system in the fuel injector 103. During fuel injection events, a return orifice is vented, which allows the fuel pressure on the backside of the needle 107 to decay, resulting in the needle 107 opening. Additionally leakage past the needle guide is vented to the internal channels 108. Surplus fuel within the fuel injectors 103 is returned from the internal channels 108, via ports 109, through the groove 111, and into the fuel return passage 113. Fuel from the fuel return passage 113 is returned to the fuel tank via a fuel return line 121.

A similar fuel regulation operation may occur within the fuel pump 129. Optionally, surplus fuel from the fuel pump 129 may be supplied via a surplus fuel line 135 through port 137 that accesses the fuel return passage 113. Thus, surplus fuel from the fuel injectors 103 and the fuel pump 129 may be returned to the fuel tank 123 via the same fuel return passage 113. Alternatively, surplus fuel from the fuel pump 129 may be returned directly to the fuel tank 123 via a line external to the cylinder head 101. Typically, the surplus fuel from the fuel injectors 103 and the fuel pump 129 is at low pressure, although the system may be adapted for use with high-pressure surplus fuel.

The present invention may be applied to inline engines, such as an I-6 engine, or to V-type engines, such as a V-6 or V-8 engine. An advantage of the present invention is that a cylinder head that has a fuel supply passage, for example, as may be utilized with hydraulically-actuated electronically-controlled injector fuel system, may be utilized for an engine utilizing a high-pressure common-rail fuel system, without having to modify the cylinder head, by utilizing the fuel supply passage as a fuel return passage. Further advantage is obtained by eliminating the need for external fuel return tubes from each of the fuel injectors. In addition, the cylinder head fuel passage may also be utilized to collect surplus fuel from the fuel pump, thereby allowing all return fuel (from the fuel injectors and the pump) to be collected at and delivered from the same location while utilizing a single return assembly. No accumulator tank is needed. A fuel cooler may be eliminated by use of sleeves disposed between the cylinder head and the fuel injectors. Thus, the engine compartment is simplified, space is reduced, the number of engine components is reduced, and the risk of fuel leakage in the engine compartment is reduced.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method comprising the steps of:
receiving, from a common rail fuel system, high pressure fuel by a plurality of fuel injectors disposed in a cylinder head of an internal combustion engine;
cooling the surplus fuel by a sleeve disposed between the fuel injector and the cylinder head;
returning surplus fuel within the fuel injector through an internal channel of the fuel injector, out through at least one port of the fuel injector, and into a fuel return passage in the cylinder head.

2. The method of claim 1, further comprising the step of directing fuel from the at least one port of the fuel injector into a groove that encircles at least a part of the outer diameter of the fuel injector.

3. (Canceled)

4. The method of claim 1, further comprising the step of sealing the at least one port of the fuel injector from the cylinder head.

5. The method of claim 1, further comprising the step of sealing the fuel return passage in the cylinder head and the at least one port of the fuel injector with a first O-ring disposed on the fuel injector at a location above the fuel return passage in the cylinder head and with a second O-ring disposed on the fuel injector at a location below the fuel return passage in the cylinder head.

6. The method of claim 1, further comprising the step of returning further comprises the step of returning surplus fuel within the fuel injector through an internal channel of the fuel injector, out through at least one port of the fuel injector that is at least partially disposed in the fuel return passage in the cylinder head.

7. The method of claim 1, further comprising the step of returning fuel from the fuel return passage to a fuel tank for the internal combustion engine.

8. The method of claim 1, further comprising the step of returning surplus fuel from a fuel pump to the fuel return passage.

9. A fuel injector arranged and constructed to perform the method of claim 1.

10. An internal combustion engine comprising:
a cylinder head having a fuel return passage including one or more openings;
one or more fuel injectors disposed within the cylinder head, wherein the one or more fuel injectors comprise an internal passage arranged and constructed to deliver surplus fuel through one of the one or more openings into the fuel return passage of the cylinder head, and wherein at least a part of at least one of the one or more fuel injectors is disposed at least partially in the one of the one or more openings in the fuel return passage;
one or more sleeves disposed between the one or more fuel injectors and the cylinder head such that cooling of the surplus fuel in the one or more fuel injectors is provided by the one or more sleeves;
a common rail arranged and constructed to provide fuel to the one or more fuel injectors.

11. The internal combustion engine of claim 10, further comprising:
a first O-ring disposed between each of the one or more fuel injectors and the cylinder head at a location above the fuel return passage;
a second O-ring disposed between each of the one or more fuel injectors and the cylinder head at a location below the fuel return passage.

12. The internal combustion engine of claim 10, wherein a length of the one or more fuel injectors is substantially perpendicular to a length of the fuel return passage.

13. The internal combustion engine of claim 10, further comprising a groove disposed between at least one of the one or more fuel injectors and the cylinder head, wherein the groove at least partially intersects the fuel return passage, such that surplus fuel from a port in the at least one of the one or more fuel injectors enters the groove and is directed into the fuel return passage.

14. (Canceled)

15. The internal combustion engine of claim 10, wherein the at least a part of at least one of the one or more fuel injectors further comprises a port through which surplus fuel enters the fuel return passage.

16. The internal combustion engine of claim 10, wherein the at least the part of at least one of the one or more fuel injectors is disposed in an opening in the fuel return passage.

17. The internal combustion engine of claim 10, further comprising a surplus fuel line, operably coupled between a fuel pump and the fuel return passage, such that surplus fuel from the fuel pump enters the fuel return passage.

18. A fuel injector comprising:
at least one fuel port arranged and constructed to receive surplus fuel from an internal passage and direct the surplus fuel out the at least one fuel port;
a groove at least partially encircling the fuel injector and arranged and constructed to receive the surplus fuel from the at least one fuel port and to deliver the surplus fuel into a fuel return passage of a cylinder head of an internal combustion engine;
a sleeve disposed an the fuel injector, such that cooling of the surplus fuel in the fuel injector is provided by the sleeve;
wherein the fuel injector is at least partially disposable in an opening in the fuel return passage, and wherein the groove is alignable with the opening in the fuel return passage.

19. The fuel injector of claim 18, further comprising an internal conduit that directs surplus fuel into at least one of the at least one fuel port.

20. The fuel injector of claim 19, wherein the internal conduit at least one of intersects with the internal passage and forms a part of the internal passage.

21. (Canceled)

22. The fuel injector of claim 18, further comprising:
a first O-ring disposed on a first outer diameter and above the groove;
a second O-ring disposed on a second outer diameter and below the groove.
